(19) United States
(12) Patent Application Publication
(10) Pub. No.: US 2026/0368597 A1
(43) Pub. Date: Nov. 19, 2026

(54) FIBER SPATIAL FILTER FOR LASER BEAM OVERLAP

(71) Applicant: IonQ, Inc., College Park, MD (US)

(72) Inventors: Stephen CRAIN, Durham, NC (US); Laird Nicholas EGAN, Annapolis, MD (US); Kai Makoto HUDEK, Hyattsville, MD (US); Joachim WELTE, Carrboro, NC (US)

(21) Appl. No.: 18/659,978

(22) Filed: May 9, 2024

Related U.S. Application Data
(60) Provisional application No. 63/501,067, filed on May 9, 2023.

(51) Int. Cl. G06N 10/60; G01H 9/00; G21K 1/20

(52) U.S. Cl. CPC G06N 10/60; G01H 9/004; G21K 1/20

(57) ABSTRACT

Aspects of the present disclosure relate generally to systems for use in the implementation and/or operation of quantum information processing (QIP) systems, and more particularly, to a fiber spatial filter for laser beam overlap.

### CROSS-REFERENCE TO RELATED APPLICATION

This application claims the benefit of and priority to U.S. Provisional Patent Application No. 63/501,067, filed May 9, 2023, the contents of which application are hereby incorporated by reference herein in their entireties.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of a fiber spatial filter configured to supply laser beams having different frequencies and a common output orientation and/or output mode. The fiber spatial filter can be mechanically and optically coupled to an acousto-optical modulator included in a QIP system.

In an aspect, the disclosure describes a system. The system includes an acousto-optic modulator (AOM) apparatus configured to receive a laser beam and further configured to modulate the laser beam to one or more particular frequencies. The system also includes a spatial filter mechanically and optically coupled to the AOM apparatus. The spatial filter is configured to receive the modulated laser beam, and also is configured to propagate the modulated laser beam into a free-space path at a defined angle. The system also includes a device configured to propagate, at the defined angle, the modulated laser beam into a second free-space path.

In another aspect, the disclosure describes a quantum information processing (QIP) system. The QIP system includes a laser source apparatus configured to supply a laser beam. The QIP system also includes an acousto-optic modulator (AOM) apparatus configured to receive the laser beam and further configured to modulate the laser beam to a particular frequency; a spatial filter mechanically and optically coupled to the AOM apparatus, where the spatial filter is configured to receive the modulated laser beam, and also is configured to cause propagation of the modulated laser beam through a free-space path at a defined angle; and an acousto-optic deflector (AOD) apparatus configured to receive the modulated laser beam that passed through the spatial filter, and further configured to propagate, at the defined angle, the modulated laser beam into a second free-space path. The QIP system also includes an ion trap comprising multiple ion qubits individually addressable by the modulated laser beam.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4A illustrates an example of a Raman laser system in accordance with aspects of this disclosure.

FIG. 4B illustrates an example of a spatial filter in accordance with aspects of this disclosure.

FIG. 5 illustrates an example of the path adjuster assembly and an example of an acousto-optic modulator (AOM) apparatus in accordance with aspects of this disclosure.

FIG. 6 illustrates and example of an acousto-optic deflector (AOD) apparatus in accordance with aspects of this disclosure.

FIG. 7 illustrates an example of another Raman laser system in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

This disclosure recognizes and addresses, among other technical challenges, the issues of beam pointing and beam displacement that typically occur in downstream optics in optical systems that use acousto-optic modulators (AOMs). Such issues may be exacerbated in quantum computing systems that address qubits optically by means of deflected laser beams and also use frequency-shifted laser beams that are deflected by an AOM. For example, in quantum computing system that rely on trapped atomic ions as qubits, the focus inside the AOM may be imaged onto the ions. Thus, a change in AOM frequency may then introduce a beam pointing error onto the ions. Further, frequency-shifted laser beams with different frequencies may not overlap precisely on the ions, depending on aberration and/or distortion present in the optical system. Consequently, ease-of-alignment, stability, heating rates, and/or qubit gate fidelity may be diminished.

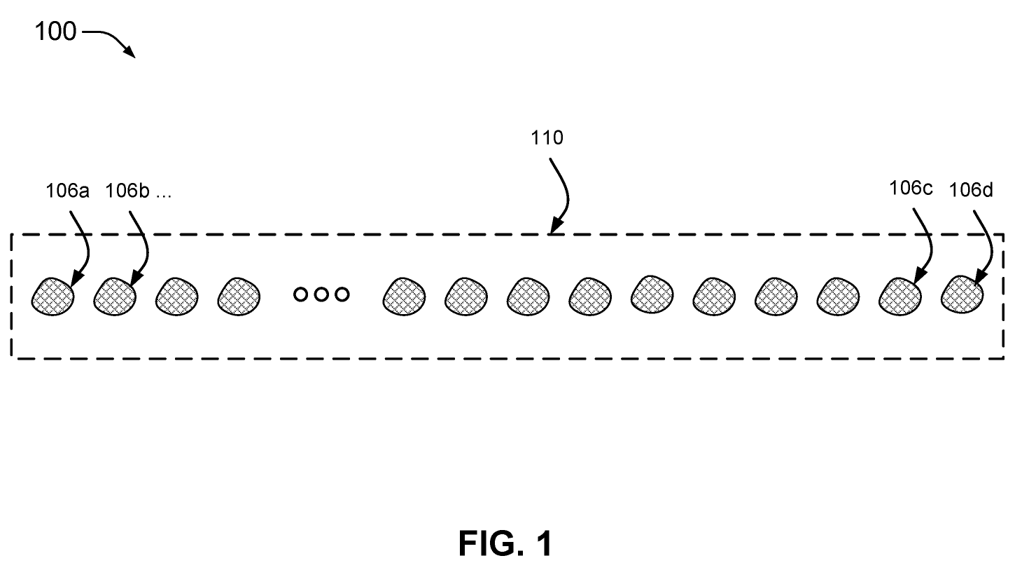

Exemplary configurations and embodiments that address the issues described above are explained in more detail in connection with FIGS. 1-7, with 1-3 providing a general description of QIP systems or quantum computers, and more specifically, of atomic-based QIP systems or quantum computers.

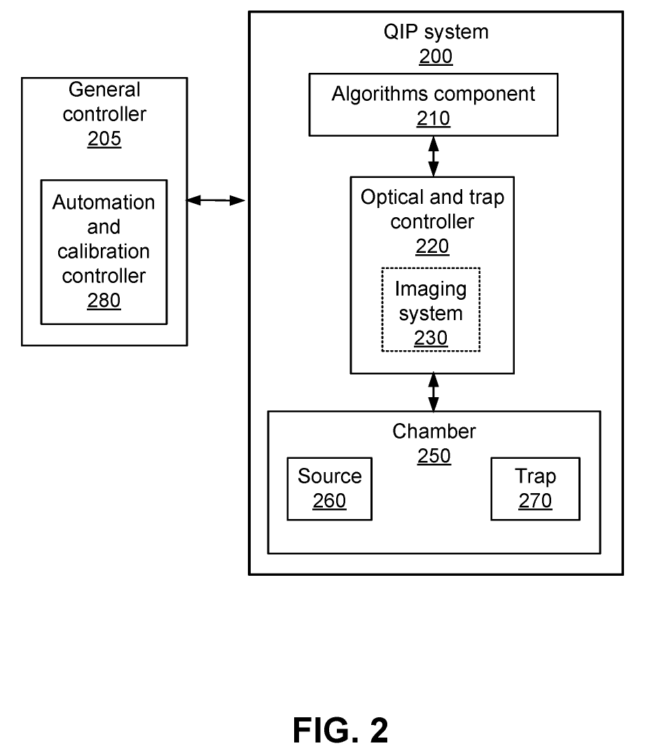

FIG. 1 illustrates a diagram 100 with multiple atomic ions or ions 106 (e.g., ions 106a, 106b, …, 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 described above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 described above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the laser beams, optical components, and optical systems described above to mitigate, or in some cases, completely remove, beam pointing issues and/or beam alignment issued that may occur as part of addressing ion qubits confined in the ion trap 270.

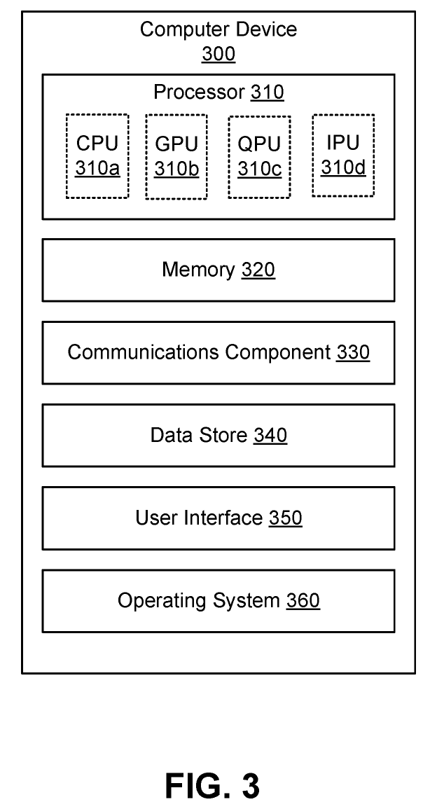

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, embodiments of this disclosure provide QIP systems that include a spatial filter that is coupled mechanically and optically to an AOM within the system. The spatial filter can be formed from a segment of an optical fiber, and may thus be referred to as a fiber spatial filter. The segment has a length, along the fiber axis, that is configured to propagate of a laser beam at a defined angle irrespective of the frequency of the laser beam. As a result, the introduction of such a spatial filter within a QIP system, such as the QIP system 200 (FIG. 2) may reduce, if not entirely avoid, beam pointing issues or beam overlap issues that typically afflict some existing QIP systems.

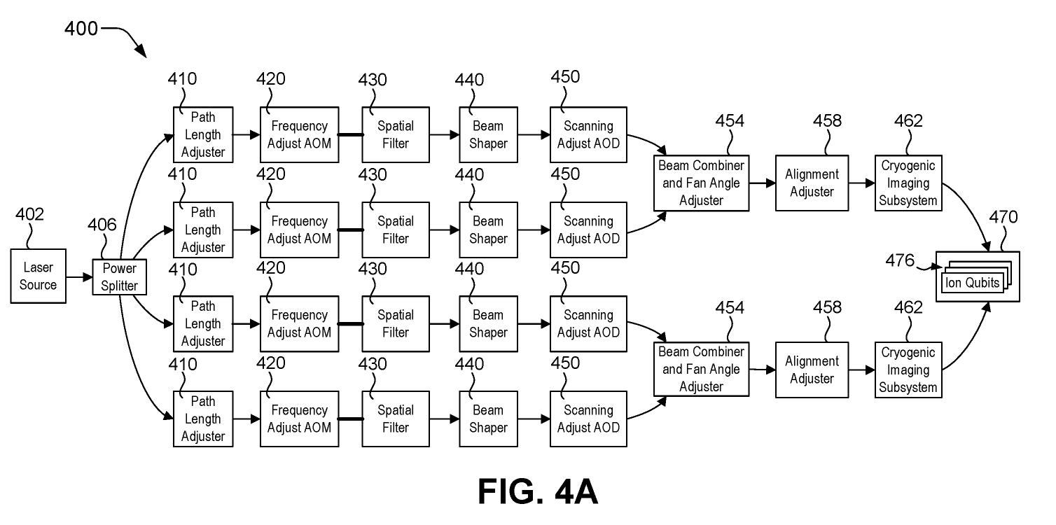

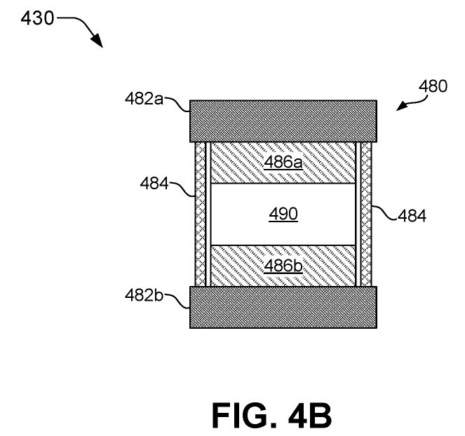

FIG. 4A illustrates an example of a Raman laser system 400 in accordance with aspects of this disclosure. The Raman laser system 400 can be part of the QIP system 200 (FIG. 2) or any other QIP system in accordance with aspects of this disclosure. It is to be understood that the various components of the example Raman laser system 400 described in FIG. 4A are described at a high-level for ease of understanding. Such components may include one or more sub-components, the details of which may be provided below as needed to better understand certain aspects of this disclosure.

The example Raman laser system 400 includes a laser source apparatus 402 configured to generate and supply a laser beam. In some configurations, the laser beam may be a continuous-wave laser beam. In other configurations the laser beam may be a pulsed laser beam. Regardless of its type, the laser source apparatus 402 supplies the laser beam to a power splitter assembly 406 that is configured to transmit respective portions of the laser beam into four separate optical paths. The disclosure, of course, is not limited in this respect, and power splitter assembly 406 can transmit respective portions of the laser beam into more or fewer separate optical paths. In each optical path, a respective portion of the laser beam may propagate into a path adjuster apparatus 410. The path adjuster apparatus 410 is configured to adjust a length of the optical path. In this way, respective optical trajectories of the optical paths may have a uniform length across the optical paths. The path adjuster apparatus 410 may be referred to as path length adjuster, simply for the sake of nomenclature.

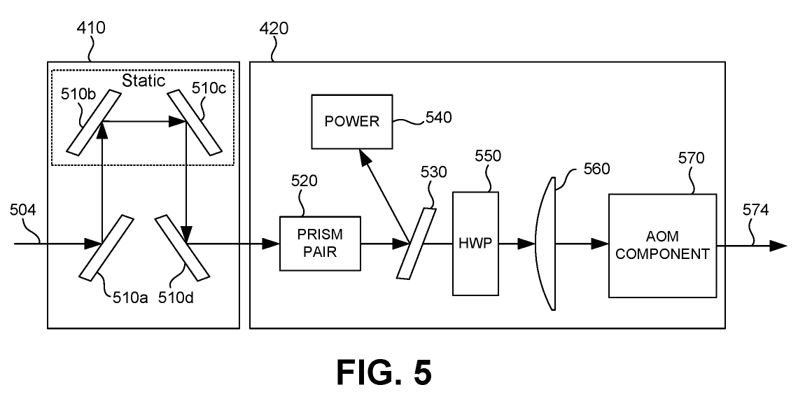

Additionally, each optical path includes an acousto-optic modulator (AOM) apparatus 420 configured to adjust a frequency of the portion of the laser beam that propagates along the optical path. That is, the AOM apparatus 420 is configured to operate on the portion of the laser beam to generate a modulated laser beam that is substantially monochromatic and has a desired frequency. The portion of the laser beam is operated upon in response to propagating through multiple optical elements and an AOM component that form the AOM apparatus 420. By adjusting the frequency of the portion of the laser beam to the desired frequency, one or more quantum gates can be controlled and, thus, applied in computations using the example Raman laser system 400. The AOM apparatus 420 may be referred to as frequency adjust AOM, simply for the sake of nomenclature. As an illustration, FIG. 5 presents an example of the path adjuster apparatus 410 and the AOM apparatus 420. The pass adjuster apparatus 410 receives an incident laser beam 504 and adjusts the optical pass via four mirrors, a first mirror 510a, a second mirror 510b, a third mirror 510c, and a fourth mirror 510d. The path-adjusted laser beam propagates to the AOM apparatus 420. As is illustrated in FIG. 5, the AOM apparatus 420 includes a prism pair 520. After incoming light has propagated through the prism pair 520, the incoming light is incident on a beam splitter 530 that also is part of the AOM apparatus 420. The beam splitter 530 permits passage of a first portion of the incoming light and reflects a second portion of the incoming light towards a power probe 540. The AOM apparatus 420 also includes a half waveplate 550 (HWP 550) that conditions or otherwise prepares incoming light for modulation. For example, the HWP 550 can rotate an angle of linear polarization of the incoming light to an orientation (e.g., horizontal) that is appropriate for modulation. After the incoming light has passed through the HWP 550, the incoming light is incident on a plano-convex lens 560. The AOM apparatus 420 includes an AOM component 570 that receives light from the plano-convex lens 560 and modulates the incoming light, resulting in a modulated laser beam 574.

For different frequencies, the AOM apparatus 420 can be configured to generate laser beams having different angles of incidence relative to a defined optical axis. The ion qubits 476 can include, in one example, at least some of the ions 106 (FIG. 1). Accordingly, in each optical path, the example Raman laser system 400 includes a spatial filter 430 that is mechanically and optically coupled to the AOM apparatus 420. In FIG. 4A, such a coupling is represented by a thick, arrowless line. The spatial filter 430 is configured to receive a modulated laser beam from the AOM apparatus 420, and is also configured to cause propagation of the modulated laser beam into free space, at a distal end relative to the AOM apparatus 420. As described above, that modulated laser beam results from the portion of the laser beam in the optical path including the AOM apparatus 420, after the portion of the laser beam is operated upon by the AOM apparatus 420. The modulated laser beam has one or more defined frequencies that are configurable. In some cases, the AOM apparatus 420 can be supplied with two RF frequencies in order to generate and output two tones.

In an exemplary embodiment, the spatial filter 430 may be formed from, or may include, a segment of an optical fiber. The optical fiber has one or more cores and cladding surrounding the core(s). The segment of the optical fiber has a length that is suitable to attenuate—or in some cases, remove altogether—high-order propagation modes and to permit propagation of the fundamental mode of the optical fiber. In some cases, such a length can be in a range from about 5 mm to about 100 mm. The optical fiber may be a single-mode optical fiber. In addition, or in another aspect, the optical fiber may be formed from silica or a rare-earth doped glass, or may be a photonic crystal fiber (PCF). The disclosure, however, is not limited to such aspects, and other types of optical fiber can be contemplated.

A suitable length of the segment of optical fiber may be determined based on various phenomena. For example, the length of segment of the optical fiber can be configured to extinguish higher order (non-Gaussian) modes or otherwise cause satisfactory extinction of such modes. As such, the length of the segment of the optical fiber can be a minimum length that causes extinction of higher order (non-Gaussian) modes. In some cases, the length can range from about 1 nm to about 100 nm. In addition, or as another example, in a scenario where the laser source apparatus 402 is configured to generate pulsed lasers, the suitable length may be determined based on the dependence of a threshold for spontaneous Raman scattering (SRS) inside the optical fiber, Brillouin scattering, a combination thereof, or the like. Such a threshold scales inversely to the length of the optical fiber. Thus, the length of the optical fiber can be adjusted until SRS and/or Brillouin scattering is absent from the optical fiber. As is described herein, the four optical paths and equipment therein form one example of a Raman laser system. The Raman laser system may use pairs of counter-propagating beams. Accordingly, a suitable length may be determined based on the dependence of phase shift with length of an optical fiber forming the spatial filter 430. Specifically, the length of the optical fiber can be adjusted until a satisfactory fidelity has been attained for the example Raman laser system 400. In some cases, the length of the optical fiber can be longer than a geometric segment that contains the optical fiber. That is, the mechanical footprint of the optical fiber need not be the same as the length of the optical fiber. Indeed, the optical fiber can be wounded in multiple turns along a segment that is shorter than the length of the optical fiber. The optical fiber so wounded can be coated with resin to reduce effects of phase shifts due to temperature changes, mechanical stress, vibrations, a combination thereof, or similar factors. The resin coating can maintain the optical fiber statically in place, thus reducing fiber phase noise. Regardless of whether the optical is wounded around along a member, the segment of the optical fiber ultimately extends from a first end to a second end that is separated by a defined distance (e.g., about 50 mm) from the first end.

Besides relying on a resin coating (e.g., an epoxy resin coating) to maintain the optical fiber statically in place, a support structure can be used in some cases. As is illustrated in the schematic diagram shown in FIG. 4B, the spatial filter 430 can include a support structure 480 that maintains an optical fiber 490 that constitutes the segment of optical fiber present in the spatial filter 430. Simply for the sake of illustration, the schematic diagram shown in FIG. 4B represents a view (cross-sectional view or plan view, for example) of the spatial filter 430. The optical fiber 490 is depicted as a block simply for the sake of simplicity. The support structure 480 can include an assembly having a first rigid panel 482a and a second rigid panel 482b that are affixed (e.g., bolted, glued, or clamped) together by means of one or more attachment members 484. The assembly also can include a first layer 486a of a soft material and a second layer 486b of the soft material surrounding the optical fiber 490. The soft material can be a foam material, for example. In this fashion, the support structure 480 can maintain the optical fiber 490 statically in place, thus reducing fiber phase noise without reliance on a resin coating. It is noted that while the attachment member(s) 484 are depicted in FIG. 4B as being assembled so as to be spaced apart from the optical fiber 490, the first layer 486a, and the second layer 486b, the disclosure is not limited in that respect.

Although the example support structure 480 is illustrated as being part of the spatial filter 430, the disclosure is not limited in that respect. Further, the example support structure 480 can have other architectures besides the one schematically depicted in FIG. 4B.

With further reference to FIG. 4A, regardless of the physical attributes of the optical fiber that form the spatial filter 430, the spatial filter 430 is configured to control modulated laser beams having different frequencies to propagate from the spatial filter 430, with essentially a same angle across bandwidth of the AOM apparatus 420. Such beams may be propagated into free space from a core of an optical fiber that forms the spatial filter 430. That angle of propagation of the modulated laser beams may be adjusted by configuring one or a combination of fiber mode, polish, refractive index. With respect to polish, some fibers have a polished angle (referred to as angled physical contact (APC) fibers) to avoid backreflections. With respect to refractive index, which depends on the material of the optical fiber, a hollow core fiber has refractive index of air, whereas a fused silica fiber has refractive index of fused silica fiber mode depends on the fiber type. Further, in connection with fiber mode, regular single mode fibers can have a fairly round Gaussian mode. Photonic crystal fibers often have a mode with somewhat hexagonal shape. Without intending to be bound by modeling, in some configurations involving a c.w. laser beam, such an output at an essentially defined angle can occur when AOM-fiber coupling efficiency bandwidth permits the coupling of the bandwidth of the first frequency-shifted order from the AOM apparatus 420 into the optical fiber with sufficiently high intensity.

As is illustrated in FIG. 4A, each one of the optical paths includes a beam shaper apparatus 440 configured to receive a modulated laser beam (e.g., a continuous-wave laser beam) from the spatial filter 430. To that end, the segment of the optical fiber that may form the spatial filter 430 may extend outwardly from the AOM apparatus 420 and may be assembled to transmit the modulated laser beam towards the beam shaper apparatus 440 through a free-space path. It is noted that in FIG. 4A, free-space paths are represented with arrows.

The beam shaper apparatus 440 also may be configured to operate on a received modulated laser beam to generate another laser beam shaped as a Gaussian beam, for example. The modulated laser beam is operated upon in response to propagating through one or multiple optical components (e.g., lenses) that form the beam shaper apparatus 440.

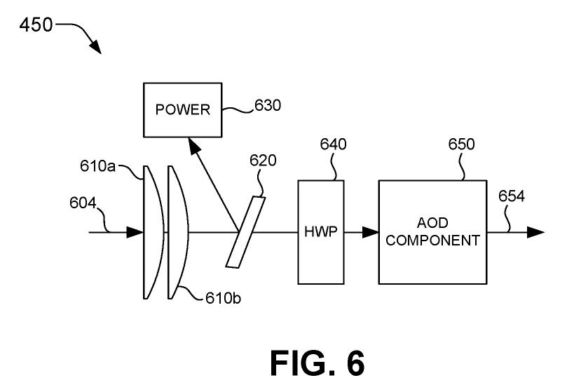

The laser beam that is generated by the beam shaper apparatus 440 may propagate, through a free-space path, towards an acousto-optic deflector (AOD) apparatus 450 that permits performing an addressing operation involving one or more of the multiple ion qubits 476. To that end, the AOD apparatus 450 may be configured to receive the laser beam and to propagate that laser beam towards the ion trap 470 at a defined angle. The defined angle can be configured by applying a particular frequency to the AOD apparatus 450. The AOD apparatus 450 may be referred to as scanning adjust AOD, simply for the sake of nomenclature. Simply as an illustration, FIG. 6 presents an example of the AOD apparatus 450. The AOD apparatus 450 can receive an incident laser beam 604. The AOD apparatus 450 include a first plano-convey lens 610a and a second plano-convey lens 610b. The AOM apparatus 450 also includes a beamsplitter 620 that permits passage of a first portion of incoming light and reflects a second portion of the incoming light towards a power probe 630. The AOD apparatus 450 also includes a half waveplate 640 (HWP 640) that conditions or otherwise prepares incoming light for deflection. For example, the HWP 640 can rotate an angle of linear polarization of the incident light to an orientation (e.g., horizontal) that is appropriate for deflection. The AOD apparatus 450 further includes an AOD component 650 that deflects the incident laser beam 604 to a defined angle, resulting in a deflected laser beam 654.

It is noted that the disclosure is not limited to the AOD apparatus 450. Indeed, the AOD apparatus 450 can be replaced by one or more devices that can scan the laser beam across an angle range or controllably displace the laser beam so as to address different trapped ions individually. Example of a device that can replace the AOD apparatus 450 include a fast random-access mirror, a spatial light modulator, and a micro mirror array.

As is illustrated in FIG. 4A, a first optical path and a second optical path converge at a first combiner/adjuster assembly 454, and second optical path and a third optical path converge at a second combiner/adjuster assembly 454. The first combiner/adjuster assembly 454 may be configured to combine a first laser beam from a first AOD assembly 454 and a second laser beam from a second AOD apparatus 450. The combined laser beam propagates to an alignment adjuster apparatus 458 that may be configured to align the combined laser beam, and to propagate the aligned laser beam towards a cryogenic imaging subsystem 462 and, in turn, towards the ion trap 470. Further, the second combiner/adjuster assembly 454 may be configured to combine a third laser beam from a third AOD apparatus 450 and a fourth laser beam from a fourth AOD apparatus 450. The combined laser beam propagates to a second alignment adjuster apparatus 458 that may be configured to align the combined laser beam, and further configured to propagate the aligned laser beam towards a second cryogenic imaging subsystem 462 and, in turn, towards the ion trap 470. As described above, the ion trap 470 includes multiple ion qubits 476 that are individually addressable by each one of the foregoing first and second combined laser beams.

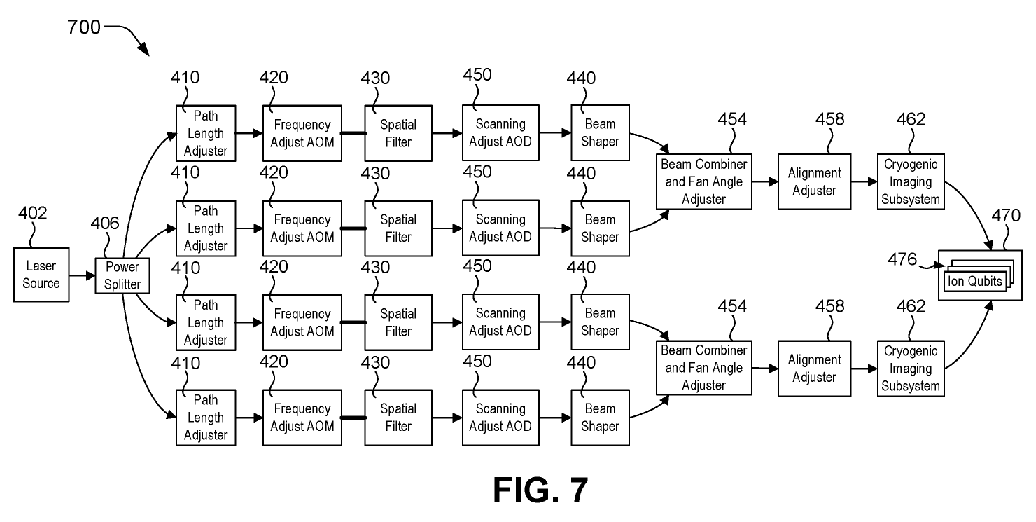

It is generally noted that the disclosure is not limited to the assembly of apparatuses illustrated in the example Raman laser system 400 (FIG. 4A). Indeed, the beam shaper apparatus 440 may be assembled further downstream within each optical path defined by the power splitter assembly 406. Simply as an illustration, FIG. 7 is a block diagram of an example of a Raman laser system 700 in accordance with aspects of this disclosure. The Raman laser system 700 may operate in the same fashion as the example Raman laser system 400. In the Raman laser system 700, however, the beam shaper apparatus 440 is assembled further downstream within each optical path defined by the power splitter assembly 406. The Raman laser system 700 also can be part of any of the QIP systems described in this disclosure. For example, the Raman laser system 700 can be part of the QIP system 200 (FIG. 2).

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A system comprising:
an acousto-optic modulator (AOM) apparatus configured to receive a laser beam and further configured to modulate the laser beam to one or more particular frequencies;
a spatial filter mechanically and optically coupled to the AOM apparatus, the spatial filter configured to receive the modulated laser beam, and further configured to propagate the modulated laser beam into a free-space path at a defined angle; and
a device configured to propagate, at the defined angle, the modulated laser beam into a second free-space path.

2. The system of claim 1, wherein the laser beam is a continuous-wave laser beam or a pulsed laser beam.

3. The system of claim 1, wherein the device comprises an acousto-optic deflector (AOD) device.

4. The system of claim 1, wherein the spatial filter is formed from a segment of an optical fiber.

5. The system of claim 4, wherein the optical fiber has one or more transmission modes within a core of the optical fiber.

6. The system of claim 4, wherein the segment of the optical fiber extends unwounded from a first end to a second end and has a length in a range from about 5 mm to about 100 mm.

7. The system of claim 4, wherein the segment of the optical fiber comprises multiple turns of the optical fiber that are coated with a resin, and wherein the resin maintains the optical fiber statically in place.

8. The system of claim 4, wherein the spatial filter comprises a support structure that maintains the optical fiber statically in place.

9. The system of claim 7, wherein the segment of the optical fiber extends from a first end to a second end that is separated by a distance of about 50 mm from the first end, and wherein the multiple turns of the optical fiber span a length configured to cause extinction of higher order modes.

10. The system of claim 4, wherein the segment of the optical fiber extends outwardly from the AOM apparatus and is assembled to transmit the modulated laser beam towards a beam shaper through free space.

11. The system of claim 4, wherein the optical fiber comprises one of silica or a rare-earth doped glass.

12. The system of claim 4, wherein the optical fiber comprises a photonic crystal fiber.

13. A quantum information processing (QIP) system comprising:
a laser source apparatus configured to supply a laser beam;
an acousto-optic modulator (AOM) apparatus configured to receive the laser beam and further configured to modulate the laser beam to a particular frequency;
a spatial filter mechanically and optically coupled to the AOM apparatus, the spatial filter configured to receive the modulated laser beam, and further configured to cause propagation of the modulated laser beam through a free-space path at a defined angle;
an acousto-optic deflector (AOD) apparatus configured to receive the modulated laser beam that passed through the spatial filter, and further configured to propagate, at the defined angle, the modulated laser beam into a second free-space path; and
an ion trap comprising multiple ion qubits individually addressable by the modulated laser beam.

14. The QIP system of claim 13, wherein the spatial filter is formed from a segment of an optical fiber.

15. The QIP system of claim 14, wherein the segment of the optical fiber has a length in a range from about 5 mm to about 100 mm.

16. The QIP system of claim 14, wherein the segment of the optical fiber comprises multiple turns of the optical fiber that are coated with a resin, and wherein the resin maintains the optical fiber statically in place.

17. The QIP system of claim 16, wherein the segment of the optical fiber extends from a first end to a second end that is separated by a distance of about 50 mm from the first end.

18. The QIP system of claim 17, wherein the multiple turns of the optical fiber span a length configured to cause extinction of higher order modes.
